(19) United States
(12) Patent Application Publication
(10) Pub. No.: US 2013/0227053 A1
(43) Pub. Date: Aug. 29, 2013

(54) Method and Apparatus for Changing the Configuration of an Ongoing Streaming Session

(71) Applicant: Imed Bouazizi, Tampere (FI)

(72) Inventor: Imed Bouazizi, Tampere (FI)

(73) Assignee: NOKIA CORPORATION, Espoo (FI)

(21) Appl. No.: 13/162,792

(22) Filed: Jun. 17, 2011

Related U.S. Application Data
(60) Provisional application No. 61/357,055, filed on Jun. 21, 2010.

(51) Int. Cl. H04L 29/06

(52) U.S. Cl. CPC H04L 65/608
USPC 709/217

(57) ABSTRACT

A method, apparatus and computer program product are provided for notifying a client device, such as a mobile terminal, as to an upcoming change to the configuration of an ongoing streaming session such that the subsequent change to the configuration of the streaming session may be accomplished in an efficient manner. The method, apparatus and computer program product may be configured to effect the change in the configuration of the streaming session even in instances in which the ongoing streaming session is relying upon a non-persistent session control connection.

### RELATED APPLICATION

This application claims priority to U.S. Application No. 61/357,055 filed Jun. 21, 2010, which is incorporated herein by reference in its entirety.

### TECHNICAL FIELD

An example embodiment of the present invention relates generally to ongoing streaming sessions and, more particularly, to effecting changes to the configuration of an ongoing streaming session.

### BACKGROUND

Streaming applications are commonly utilized in order to deliver media and other content, such as movies, television programs, audio broadcasts or the like. With the proliferation of mobile terminals, such as mobile telephones, media players and the like, streaming applications have been developed to stream media and other content to these mobile terminals. In this regard, a Packet-switched Streaming Service (PSS) has been developed to support unicast streaming applications to stream media and other content to mobile terminals, such as via the Universal Mobile Telecommunications System (UMTS) and Long Term Evolution (LTE) networks. As a result of the relatively wide deployment of PSS by mobile terminals and mobile operators, content providers appear to be increasingly offering streaming services that rely upon PSS.

### SUMMARY OF SOME EXAMPLES

A method, apparatus and computer program product are provided according to an example embodiment for notifying a client device, such as a mobile terminal, of an upcoming change to the configuration of an ongoing streaming session such that the subsequent change to the configuration of the streaming session may be accomplished in an efficient manner. The notification of a client device, such as a mobile terminal, of an upcoming change to the configuration of an ongoing streaming session may be provided by a method, apparatus and computer program product of an example embodiment even in an instance in which the ongoing streaming session is relying upon a non-persistent session control connection to the server.

In an example embodiment, a method for changing the configuration of an ongoing streaming session is provided. The method comprises determining that a configuration of an ongoing streaming session is to change. For example, a server determines that the configuration of an ongoing streaming session is to change by receiving an indication that a session update is scheduled for the ongoing streaming session. The method of this embodiment also comprises causing a notification related to the change of the configuration of the ongoing streaming session to be provided to a client device. For example, the notification may be a RTCP message. The notification is sent to the client device to cause the same client device to establish a session control connection to the server. Upon establishing the session control connection to the server by the client device, the method comprises causing a session message to be sent to the client device through the established session control connection. The session message may inform the client device of a session update that changes the configuration of the ongoing streaming session. For example, the session message may be an RTSP message.

In an example embodiment, the notification comprises a request for establishing a session control connection. Alternatively, the notification comprises an indication of an outstanding session message. The notification may be transmitted in-band, for example, within data packets of the ongoing streaming session. The session message may comprise at least one of a new session description, an update to the session description of the ongoing streaming session and an indication of the time at which the session update becomes effective, such as the time at which to apply the new session description and/or to apply the update to the session description of the ongoing streaming session.

According to an example embodiment of the present invention, an apparatus is provided for changing the configuration of an ongoing streaming session. The apparatus includes at least one processor and at least one memory including computer program code. The at least one memory and the computer program code configured to, with the at least one processor, cause the apparatus to perform at least the following: determine that a configuration of an ongoing streaming session is to change, cause a notification, related to the change in the configuration of the ongoing streaming session, to be sent to a client device, wherein the notification being sent to cause the client device to establish a session control connection to the server, and upon the connection being established, the apparatus is caused to send a session message to the client device through the established session control connection. The session message, such as an RTSP message, may inform the client device of a session update that changes the configuration of the ongoing streaming session. In one embodiment, the notification may be a RTCP message. In determining an upcoming change in the configuration of the ongoing streaming session, the apparatus is, for example, caused to receive an indication that an update of the ongoing streaming session is scheduled. The notification sent to the client device comprises, for example, a request for establishing a session control connection and/or an indication of an outstanding message session. The notification may be transmitted in-band, for example, within data packets of the ongoing steaming session. The session message, sent to the client device, may comprise at least one of a new session description, an update to the session description of the ongoing streaming session and an indication of the time at which the session update becomes effective, such as the time at which to apply the new session description and/or to apply the update to session description of the ongoing session.

In an example embodiment, a computer program product for changing the configuration of an ongoing streaming session is provided. The computer program product comprises at least one computer-readable storage medium having computer-readable program code portions stored therein. The computer-readable program code portions, when executed by a processor, cause an apparatus to determine that a configuration of an ongoing streaming session is to change, such as by receiving an indication that a session update is scheduled for the ongoing streaming session and to cause a notification related to the change of the configuration of the ongoing streaming session to be provided to a client device. For example, the notification may be a RTCP message. The notification is sent to the client device to cause the same client device to establish a session control connection to the server. Upon establishing the session control connection to the server by the client device, the computer-readable program code portions of this embodiment, when executed by the processor, cause the apparatus to cause a session message to be sent to the client device through the established session control connection. The session message may inform the client device of a session update that changes the configuration of the ongoing streaming session. For example, the session message may be an RTSP message.

In an example embodiment, the notification comprises a request for establishing a session control connection. Alternatively, the notification comprises an indication of an outstanding session message. The notification may be transmitted in-band, for example, within data packets of the ongoing streaming session. The session message may comprise at least one of a new session description, an update to the session description of the ongoing streaming session and an indication of the time at which the session update becomes effective such as the time at which to apply the new session description and/or to apply the update to the session description of the ongoing streaming session.

In an example embodiment, an apparatus for changing the configuration of an ongoing streaming session is provided. The apparatus comprises means for determining that a configuration of an ongoing streaming session is to change. For example, a server determines that the configuration of an ongoing streaming session is to change by receiving an indication that a session update is scheduled for the ongoing streaming session. The apparatus of this embodiment also comprises means for causing a notification related to the change of the configuration of the ongoing streaming session to be provided to a client device. For example, the notification may be a RTCP message. The notification is sent to the client device to cause the same client device to establish a session control connection to the server. Upon establishing the session control connection to the server by the client device, the apparatus comprises means for causing a session message to be sent to the client device through the established session control connection. The session message may inform the client device of a session update that changes the configuration of the ongoing streaming session. For example, the session messag may be an RTSP message.

In an example embodiment, the notification comprises a request for establishing a session control connection. Alternatively, the notification comprises an indication of an outstanding session message. The notification may be transmitted in-band, for example, within data packets of the ongoing streaming session. The session message may comprise at least one of a new session description, an update to the session description of the ongoing streaming session and an indication of the time at which the session update is to become effective such as the time at which to apply the new session description and/or to apply the update to the session description of the ongoing streaming session. In another example embodiment of the present invention, a method for consuming a media streaming session is provided. The method comprises participating, by a client device, in an ongoing streaming session, receiving a notification, related to the ongoing streaming session, at the client device from a server, causing a session control connection to the server to be established in response to receipt of the notification, and receiving a session message at the client device from the server via the established session control connection, wherein the session message is configured to inform the client device of at least one session update that changes a configuration of the ongoing streaming session.

The method may further comprise implementing, by the client device, the change to the configuration of the ongoing streaming session. For example, one or more updated media streams may be mapped to one or more existing media streams. An existing media stream may also be replaced with an updated media stream. The notification received by the client device comprises, for example, a request for establishing a session control connection and/or an indication of an outstanding message session. The notification of one embodiment is a RTCP message. The notification may be received in-band, for example, within data packets of the ongoing streaming session. The session message, received by the client device, may comprise at least one of a new session description, an update to the session description of the ongoing streaming session and an indication of the time at which the session update becomes effective, such as the time at which to apply the new session description and/or to apply the update to the session description of the ongoing session. The session message of one embodiment is an RTSP message.

An apparatus for consuming a media streaming session is provided according to another example embodiment of the present invention that includes at least one processor and at least one memory including computer program code with the at least one memory and the computer program code configured to, with the at least one processor, cause the apparatus to at least participate in an ongoing streaming session, to receive a notification related to the ongoing streaming session, at a client device from a server, to cause a session control connection to the server to be established in response to receipt of the notification and to receive a session message at the client device from the server via the established session control connection, wherein the session message is configured inform the client device of at least one session update that changes a configuration of the ongoing streaming session.

The at least one memory and the computer code may further be configured to, with the at least one processor, cause the apparatus to implement the change to the ongoing streaming session. For example, one or more updated media streams may be mapped to one or more existing media streams. An existing media stream may also be replaced with an updated media stream. The notification received by the client device comprises, for example, a request for establishing a session control connection and/or an indication of an outstanding message session. The notification may be, for example, an RTCP message. The notification may be received in-band, for example, within data packets of the ongoing session. The session message, received by the client device, may comprise at least one of a new session description, an update to the session description of the ongoing streaming session and an indication of the time at which the session update becomes effective, such as the time at which to apply the new session description and/or to apply the update to the session description of the ongoing session. For example, the session message may be an RTSP message.

In another example embodiment, a computer program product is provided for consuming a media streaming session. The computer program product of this embodiment comprises at least one computer-readable storage medium having computer-readable program code portions stored therein. The computer-readable program code portions, when executed by a processor, cause an apparatus to receive a notification, related to the ongoing streaming session, at the client device from a server. The notification may be, for example, an RTCP message. The computer-readable program code portions of this embodiment, when executed by the processor, cause the apparatus to cause a session control connection to be established to the server in response to receipt of the notification and to receive a session message at the client device from the server via the established session control connection, wherein the session message is configured to inform the client device of at least one session update that changes a configuration of the ongoing streaming session. For example, the session message may be an RTSP message.

The computer-readable program code portions of an example embodiment may also include program code instructions for causing the change to the configuration of the ongoing streaming session to be implemented by the client device. For example, one or more updated media streams may be mapped to one or more existing media streams. An existing media stream may also be replaced with an updated media stream. The notification received by the client device comprises, for example, a request for establishing a session control connection and/or an indication of an outstanding message session. The notification may be received in-band, for example, within data packets of the ongoing session. The session message, received by the client device, may comprise at least one of a new session description, an update to the session description of the ongoing streaming session and an indication of the time at which the session update becomes effective, such as the time at which to apply the new session description and/or to apply the update to the session description of the ongoing session.

In another example embodiment of the present invention, an apparatus for consuming a media streaming session is provided. The apparatus comprises means for participating, by a client device, in an ongoing streaming session, receiving a notification, related to the ongoing streaming session, at the client device from a server, means for causing a session control connection to the server to be established in response to receipt of the notification, and means for receiving a session message at the client device from the server via the established session control connection, wherein the session message is configured to inform the client device of at least one session update that changes a configuration of the ongoing streaming session.

The apparatus may further comprise means for implementing, by the client device, the change to the configuration of the ongoing streaming session. For example, one or more updated media streams may be mapped to one or more existing media streams. An existing media stream may also be replaced with an updated media stream. The notification received by the client device comprises, for example, a request for establishing a session control connection and/or an indication of an outstanding message session. The notification may be, for example, an RTCP message. The notification may be received in-band, for example, within data packets of the ongoing session. The session message, received by the client device, may comprise at least one of a new session description, an update to the session description of the ongoing streaming session and an indication of the time at which the session update becomes effective, such as the time at which to apply the new session description and/or to apply the update to the session description of the ongoing session. For example, the session message may be an RTSP message.

### BRIEF DESCRIPTION OF THE DRAWING(S)

Having thus described the embodiments of the invention in general terms, reference will now be made to the accompanying drawings, which are not necessarily drawn to scale, and wherein:

FIG. 1 is a representation of a protocol stack for supporting unicast streaming in accordance with the Packet-switched Streaming Service (PSS);

FIG. 2 is a block diagram of a system for supporting a change to the configuration of an ongoing streaming session in accordance with an example embodiment of the present invention;

FIG. 3 is a block diagram of a network node configured to notify a client device, such as a mobile terminal, of a change to the configuration of a ongoing streaming session in accordance with an example embodiment of the present invention;

FIG. 4 is a block diagram of a mobile terminal configured to facilitate a change to the configuration of an ongoing streaming session in accordance with an example embodiment of the present invention;

FIG. 5 is a flow chart illustrating operations performed by a network node in order to notify a client device, such as a mobile terminal, of a change to the configuration of a ongoing streaming session in accordance with an example embodiment of the present invention;

FIG. 6 is another flow chart illustrating operations performed by a network node in order to notify a client device, such as a mobile terminal, of a change to the configuration of a ongoing streaming session in accordance with an example embodiment of the present invention; and

FIG. 7 is a flow chart of operations performed by a client device, such as a mobile terminal, to facilitate a change to the configuration of an ongoing streaming session in accordance with an example embodiment of the present invention.

FIG. 8 is an example of an Outstanding Session Notification Message (OSNM) Application (APP) report block.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

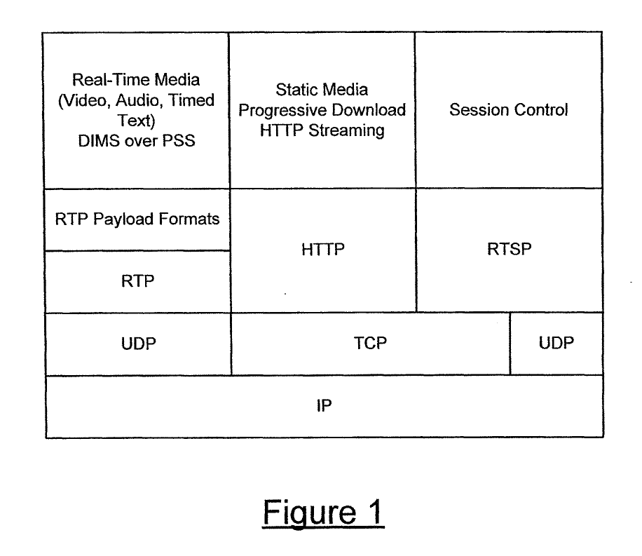

In accordance with the 3^{rd} Generation Partnership Project (3GPP), a number of aspects of PSS have been specified including the transport protocols and codecs and the 3GPP file format. In terms of protocols, PSS relies upon several protocols. As shown in FIG. 1, for example, the PSS protocol stack may utilize Real Time Streaming Protocol (RTSP) for session control, Session Description Protocol (SDP) for session description, Real-time Transport Protocol (RTP) for synchronized media data transport, e.g., real-time media, Dynamic and Interactive Multimedia Scenes (DIMS), and Hypertext Transport Protocol (HTTP) for the transport of static media, progressive downloading and adaptive streaming of timed media data; all of which are supported by Internet Protocol (IP), User Datagram Protocol (UDP) and Transmission Control Protocol (TCP) layers.

During an ongoing streaming session, such as a PSS streaming session, the session configuration may change. For example, the number of media streams may increase or decrease. As another example, the media configurations may change, such as due to changes in language, codecs, bitrates, etc. Unfortunately, a client device, such as a mobile terminal, may not generally be signaled or otherwise alerted as to upcoming changes to an ongoing streaming session. The inability to effectively signal or alert a client device, such as a mobile terminal, as to upcoming changes in an ongoing streaming session may be exacerbated by an inability to guarantee the existence of a signaling channel, such as due to the usage of non-persistent connections between the PSS server and the client device. Thus, it may be desirable to provide an improved technique for alerting a client device, such as a mobile terminal, as to upcoming changes in an ongoing streaming session in order to facilitate the implementation of such changes.

According to some example embodiments of the present invention, a method, apparatus and computer program product are provided for supporting a streaming session, such as by supporting implementation of a change in the configuration of an ongoing streaming session. In a typical example, a client device establishes a real time streaming protocol (RTSP) session with a server. The RTSP session is usually built on top of a transmission control protocol (TCP) connection. Once a connection is established, the client device and the server exchange control messages, e.g., RTSP messages. For example, the client device sends a DESCRIBE request and the server responds back with a session description protocol (SDP) file. The client device may then send a SETUP request for setting up an audio session and the server acknowledges the request and defines one or more ports for an RTP session to stream audio data. Similarly, the client device sends a SETUP request for setting up a video session and the server acknowledges the request and defines one or more ports for another RTP session to stream video data. The client device then sends a PLAY request to the server and the server starts sending media data over the RTP sessions. The client device then tears down the RTSP session and the corresponding TCP connection while the streaming of media data over the RTP sessions continues. Once the RTSP session is terminated, and the corresponding TCP session is torn down the server cannot send control messages to the client device. For example, the server cannot inform the client of an upcoming change in the configuration of an ongoing streaming session, e.g., one or both of the RTP sessions over which audio and video data is being streamed.

Once the RTSP session is terminated, and the corresponding TCP connection is torn down, the server can send RTP control protocol (RTCP) messages to the client device. However, RTCP messages are not appropriate for sending session control information. RTCP messages have a limited reserved bandwidth which is typically very low and sending, for example, large SDP messages over RTCP is not practical and may delay other related RTCP signaling. The delay is, for example, due to maintaining constant bitrate RTCP channels, e.g., once an RTCP packet is transmitted, the next one is scheduled to be transmitted after a given time duration of B/S seconds. The value B represents the bitrate per second reserved for RTCP and S is the size of the transmitted RTCP packet in bits. As an example, the RTCP bitrate in 3GPP specifications is limited to 4kbps, so that in sending an SDP of size 1000 bytes, a waiting period of 8000/4000=2 seconds would be necessary. In other words, to send the SDP 3 times for reliability, a total transmission duration of 4 seconds would be required. Furthermore, RTCP traffic is not reliable, e.g., not as reliable as RTSP, and is not an appropriate channel for critical signaling. To increase reliability, a message comprising an SDP file, for example, must be transmitted multiple times. Given the large size of SDP files, sending control information over RTCP messages may turn out not to be possible without large delays and would result in a high level of redundancy, e.g., due to the repeated transmission of the SDP.

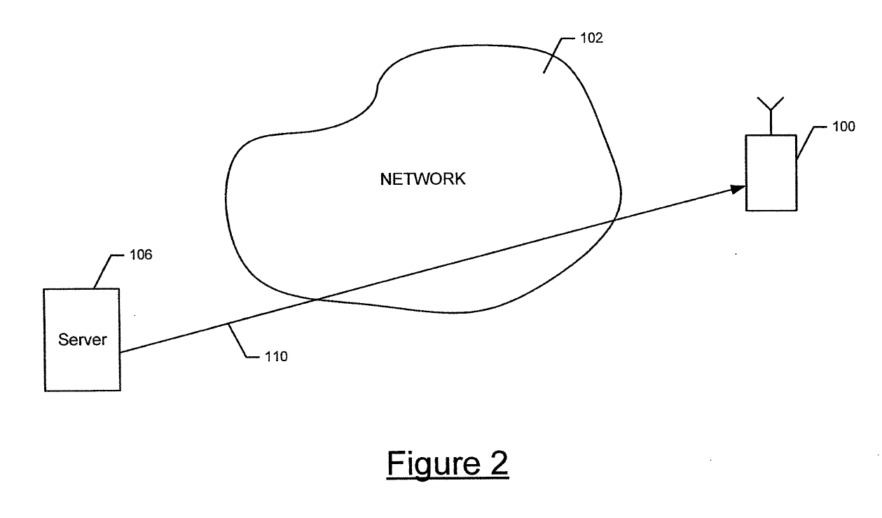

During an ongoing streaming session, it may be desirable to change the configuration of the streaming session. As such, a method, apparatus and computer program product are provided in accordance with an example embodiment for facilitating a change in the configuration of an ongoing streaming session. In this regard, FIG. 2 illustrates a system that supports streaming media and permits a change in the configuration of an ongoing streaming session to be made. The system of FIG. 2 may include a client device 100, a network 102 and a network node, such as a server 106. The client device may be any type of wired or wireless device that is configured to receive and present streaming media. The client device 100 may be a mobile terminal, e.g., a mobile phone, a stationary terminal, e.g., a personal computer, or the like. The network may be any type of wired network, wireless network, or a combination thereof including, for example, the Internet.

Via the network 102 and streaming media connection 110, the client device 100 may request and receive media data from the server 106 to be presented on a user interface of the client device. Although the system may include various types of servers, the server of one embodiment may be a streaming server and the streaming media connection supports streaming over RTP. Although a server will be described herein as providing the streaming media or other content, the server is merely one example of a network node that may provide such functionality and, as such, the subsequent discussion of the server and its functionality should be understood to be more generally applicable to a network node that is configured to perform the operations described below in conjunction with the server.

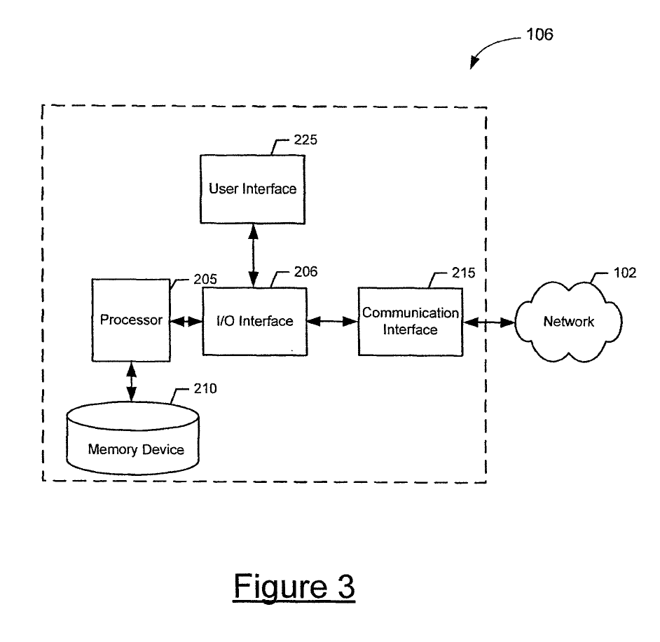

Referring now to FIG. 3, an example embodiment of an apparatus, such as server 106, for providing streaming media or other content is depicted. As shown, the server may include or otherwise be in communication with a processor 205, a memory device 210, an Input/Output (I/O) interface 206 and a communications interface 215. According to some example embodiments, the server may include a user interface 225. The processor may be embodied as various means for implementing the various functionalities of example embodiments of the present invention including, for example, a microprocessor, a coprocessor, a controller, a special-purpose integrated circuit such as, for example, an application specific integrated circuit (ASIC), a field programmable gate array (FPGA), or a hardware accelerator, processing circuitry or the like. According to one example embodiment, processor may be representative of a plurality of processors, or one or more multiple core processors, operating in concert. Further, the processor may be comprised of a plurality of transistors, logic gates, a clock, e.g., oscillator, other circuitry, and the like to facilitate performance of the functionality described herein. The processor may, but need not, include one or more accompanying digital signal processors. In some example embodiments, the processor is configured to execute instructions stored in the memory device or instructions otherwise accessible to the processor. The processor may be configured to operate such that the processor causes the server to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor is embodied as, or is part of, an ASIC, FPGA, or the like, the processor is specifically configured hardware for conducting the operations described herein. Alternatively, in example embodiments where the processor is embodied as an executor of instructions stored on a computer-readable storage medium, the instructions specifically configure the processor to perform the algorithms and operations described herein. In some example embodiments, the processor is a processor of a specific device, e.g., a communications server, configured for employing example embodiments of the present invention by further configuration of the processor via executed instructions for performing the algorithms, methods, and operations described herein.

The memory device 210 may be one or more tangible and/or non-transitory computer-readable storage media that may include volatile and/or non-volatile memory. In some example embodiments, the memory device includes Random Access Memory (RAM) including dynamic and/or static RAM, on-chip or off-chip cache memory, and/or the like. Further, memory device may include non-volatile memory, which may be embedded and/or removable, and may include, for example, read-only memory, flash memory, magnetic storage devices, e.g., hard disks, floppy disk drives, magnetic tape, etc., optical disc drives and/or media, non-volatile random access memory (NVRAM), and/or the like. Memory device may include a cache area for temporary storage of data. In this regard, some or all of memory device may be included within the processor 205. In some example embodiments, the memory device may store the various representations of the media or other content that may be streamed to the client device 100.

Further, the memory device 210 may be configured to store information, data, applications, computer-readable program code instructions, and/or the like for enabling the processor 205 to carry out various functions in accordance with example embodiments of the present invention described herein. For example, the memory device could be configured to buffer input data for processing by the processor. Additionally, or alternatively, the memory device may be configured to store instructions for execution by the processor.

The I/O interface 206 may be any device, circuitry, or means embodied in hardware, a computer program product or a combination of hardware and software that is configured to interface the processor 205 with other circuitry or devices, such as the communications interface 215. In some example embodiments, the processor may interface with the memory 210 via the I/O interface. The I/O interface may be configured to convert signals and data into a form that may be interpreted by the processor. The I/O 506 may also perform buffering of inputs and outputs to support the operation of the processor. According to some example embodiments, the processor and the I/O interface may be combined onto a single chip or integrated circuit configured to perform, or cause the server to perform, various functionalities of the present invention.

The communication interface 215 may be any device or means embodied in hardware, a computer program product, or a combination of hardware and a computer program product that is configured to receive and/or transmit data from/to a network 102 and/or any other device or module in communication with the server 106. In some example embodiments, the communications interface is configured to support the reception or transmission of steaming media content via, for example, RTP streaming, and/or information associated with streaming media content. The communications interface may be configured to communicate information via any type of wired or wireless connection, and via any type of communications protocol, such as a communications protocol that supports cellular communications. According to various example embodiments, the communication interface is configured to support the transmission and reception of communications in cellular networks. In this regard, the communications interface may be configured to support device-to-device communications. Processor 205 may also be configured to facilitate communications via the communications interface by, for example, controlling hardware included within the communications interface. In this regard, the communication interface may include, for example, communications driver circuitry, e.g., circuitry that supports wired communications via, for example, fiber optic connections, one or more antennas, a transmitter, a receiver, a transceiver and/or supporting hardware, including, for example, a processor for enabling communications. Via the communication interface, the server may communicate with various other network entities in a device-to-device fashion and/or via indirect communications via a base station, access point, server, gateway, router, or the like.

The user interface 225 may be in communication with the processor 205 to receive user input via the user interface and/or to present output to a user as, for example, audible, visual, mechanical or other output indications. The user interface may include, for example, a keyboard, a mouse, a joystick, a display, e.g., a touch screen display, a microphone, a speaker, or other input/output mechanisms. Further, the processor may comprise, or be in communication with, user interface circuitry configured to control at least some functions of one or more elements of the user interface. The processor and/or user interface circuitry may be configured to control one or more functions of one or more elements of the user interface through computer program instructions, e.g., software and/or firmware, stored on a memory accessible to the processor, e.g., volatile memory, non-volatile memory, and/or the like. The user interface may also be configured to support the implementation of haptic feedback. In this regard, the user interface, as controlled by processor, may include a vibra, a piezo, and/or an audio device configured for haptic feedback as described herein. In some example embodiments, the user interface circuitry is configured to facilitate user control of at least some functions of the server 106 through the use of a display and configured to respond to user inputs. The processor may also comprise, or be in communication with, display circuitry configured to display at least a portion of a user interface, the display and the display circuitry configured to facilitate user control of at least some functions of the server. The display circuitry may be configured to support and present steaming media, including streaming media provide via RTP streaming.

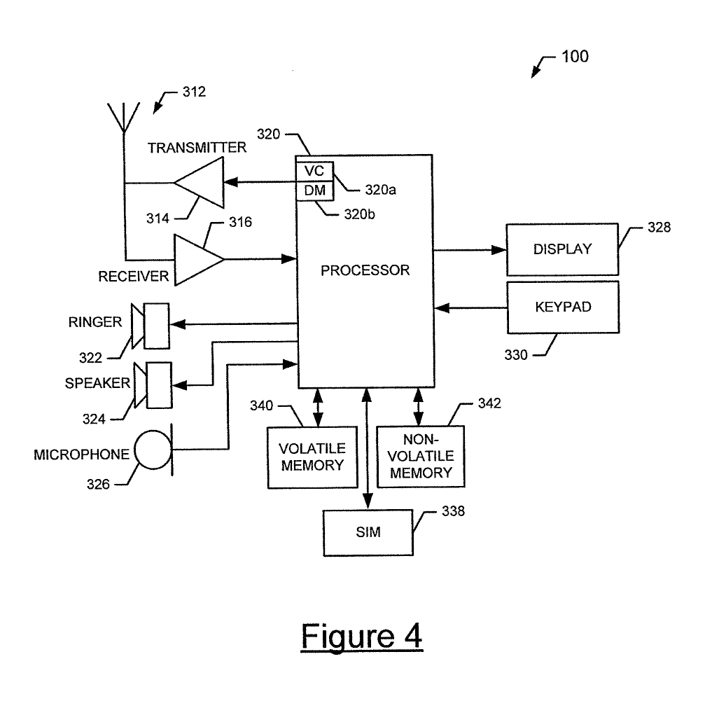

As noted above, the system may include a variety of client devices 100. In one embodiment, however, the client device may be embodied as a mobile terminal, which receives the streaming media or other content with the server 106 for presentation, for example, to a user. By way of example, a mobile terminal 300 that may serve as a client device is depicted in FIG. 4 and described below. It should be understood, however, that the mobile terminal illustrated and hereinafter described is merely illustrative of one type of client device that may implement and/or benefit from example embodiments of the present invention and, therefore, should not be taken to limit the scope of the present invention. Indeed, while one embodiment of the client device is illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 300 may include an antenna 312, or multiple antennas, in communication with a transmitter 314 and a receiver 316. The mobile terminal may also include a processor 320 configured to provide signals to and receive signals from the transmitter and receiver, respectively. The processor may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 4 as a single processor, in some embodiments the processor comprises a plurality of processors. The signals sent and received by the processor may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like.

The mobile terminal 300 may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as LTE, LTE-Advanced or E-UTRAN and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals 300 may also benefit from embodiments of this invention, as should dual or higher mode phones, e.g., digital/analog or TDMA/CDMA/analog phones. Additionally, the mobile terminal may be capable of operating according to Wi-Fi or Worldwide Interoperability for Microwave Access (WiMAX) protocols.

It is understood that the processor 320 may comprise circuitry for implementing audio/video and logic functions of the mobile terminal 300. For example, the processor may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 320a, an internal data modem (DM) 320b, and/or the like. Further, the processor may comprise functionality to operate one or more software programs, which may be stored in memory. For example, the processor may be capable of operating a connectivity program, such as a web browser. The connectivity program may allow the mobile terminal to transmit and receive web content, such as location-based content, according to a protocol, such as Wireless Application Protocol (WAP), hypertext transfer protocol (HTTP), and/or the like. The mobile terminal is configured to use a Transmission Control Protocol/Internet Protocol (TCP/IP) to transmit and receive data across the internet or other networks.

The mobile terminal 300 may also comprise a user interface including, for example, an earphone or speaker 324, a ringer 322, a microphone 326, a display 328, a user input interface, and/or the like, which may be operationally coupled to the processor 320. In this regard, the processor may comprise user interface circuitry configured to control at least some functions of one or more elements of the user interface, such as, for example, the speaker, the ringer, the microphone, the display, and/or the like. The processor and/or user interface circuitry comprising the processor may be configured to control one or more functions of one or more elements of the user interface through computer program instructions, e.g., software and/or firmware, stored on a memory accessible to the processor, e.g., volatile memory 340, non-volatile memory 342, and/or the like. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9), alphabetical (a-z) and related keys (#, *), and/or other keys for operating the mobile terminal.

The mobile terminal 300 may comprise memory, such as one or more subscriber identity modules (SIMs) 338, universal SIMs (USIMs), removable user identity modules (R-UIMs), and/or the like, which may store information elements related to a mobile subscriber. In addition to the SIM, the mobile terminal may comprise other removable and/or fixed memory. The mobile terminal may include volatile memory 340 and/or non-volatile memory 342. For example, volatile memory may include Random Access Memory (RAM) including dynamic and/or static RAM, on-chip or off-chip cache memory, and/or the like. Non-volatile memory, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory, non-volatile memory may include a cache area for temporary storage of data. The memories may store one or more software programs, instructions, pieces of information, data, and/or the like which may be used by the mobile terminal for performing functions of the mobile terminal. For example, the memories may store instructions which, when executed by the processor 320, cause the processor to perform the functions described herein. The memories may also comprise an identifier, such as an international mobile equipment identification (IMEI) code, capable of uniquely identifying the mobile terminal.

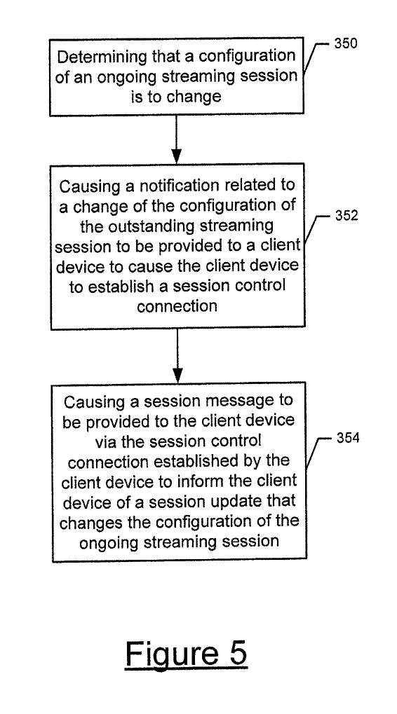

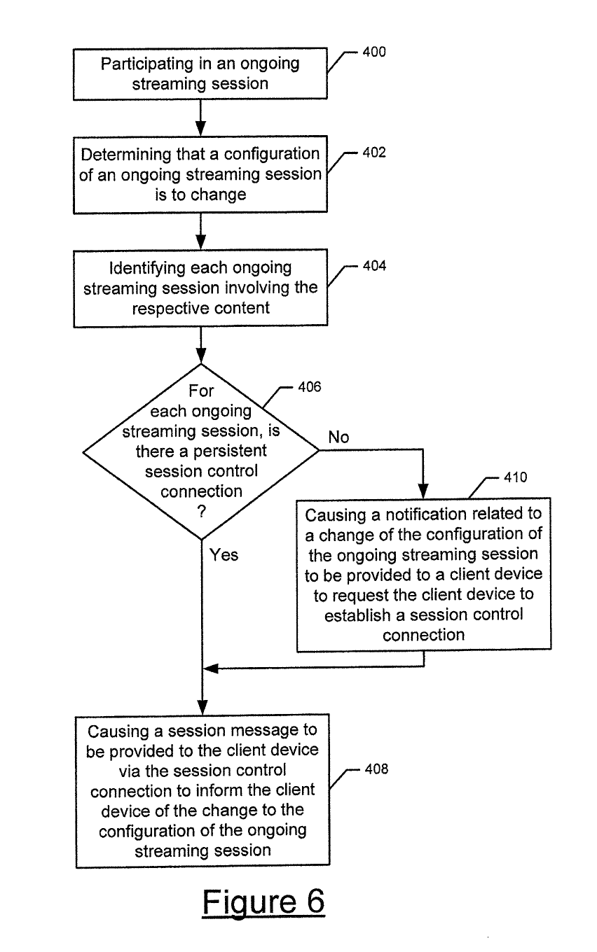

As generally shown in FIG. 2 and in more detail in a general flow chart of FIG. 5 and a more detailed flowchart of FIG. 6, a network node, such as server 106, may be participating in an ongoing streaming session with a client device 100, such as a mobile terminal 300. See operation 400 of FIG. 5. The streaming session may be a PSS streaming session in which one or more media streams are being streamed, such as via respective RTP sessions, to the client device. In this regard, the media streams may include audio, video or other forms of media or other content. In one example embodiment, the ongoing streaming session is a unicast streaming session that is set up by an RTSP session that is usually built on top of a TCP session control connection. Once media data is streamed via one or more RTP sessions, the RTSP session may be terminated and the TCP session control connection may be torn down with the RTP sessions continuing even though the RTSP session and the TCP session control connection are non-persistent.

The server 106 may include means, such as the processor 205, for determining that a configuration of the ongoing streaming session is to change. See operation 350 of FIG. 5 and operation 402 of FIG. 6. In order to determine that the configuration of an ongoing streaming session is to change, the server may include means, such as the processor, the communication interface 215 and/or the like, for receiving an indication that a session update is scheduled for the respective content that is being provided to the client device 100 via the ongoing streaming session and means, such as the processor, for identifying one or more ongoing streaming sessions that include the respective content. See operation 404 of FIG. 6. The change in the configuration of an ongoing streaming session may be known well in advance in which case, the processor may receive an indication from memory 210 of the upcoming change in configuration based upon a schedule of such changes. Alternatively, the change in the configuration of an ongoing streaming session may occur dynamically. The configuration of an ongoing streaming session may change in a variety of manners. For example, the number of media streams may increase or decrease and/or any one or more of the media configurations may change, such as due to changes in the media language, the codecs, the bit rates, the resolution, the bandwidth, etc. By way of example, a media stream in a particular language that is a preference for the client device may be unavailable at the outset of the ongoing streaming session, but may become available during the ongoing streaming session such that a change is to be made so as to subsequently deliver the media content in the preferred language to the client device. Alternatively, other types of changes may occur during an ongoing streaming session that may impact the content delivered to the client device.

In one example embodiment, the server 106 may receive an indication that a session update is scheduled for one or more respective content items. Since the respective content items that are the subject of the session update may be relevant to a plurality of ongoing streaming sessions, the server may include means, such as the processor 205, for identifying each ongoing streaming session that involves the respective content and that has not yet been advised of the impending change. The server, such as the processor, may then notify each of the client devices that are receiving the ongoing streaming sessions that include the respective content of the impending change.

For each ongoing streaming session that includes the respective content that is slated to change, the server 106 may include means, such as the processor 205, for determining if the ongoing streaming session is supported by a persistent session control connection, such as a persistent TCP session control connection supporting an RTSP session. See operation 406 of FIG. 6. In instances in which the ongoing streaming session is supported by a persistent session control connection, the server may include means, such as a processor, the communication interface 215 and/or the like, for causing a session message to be provided to the client device 100 via the session control channel in order to inform the client device of a session update that changes the configuration of the ongoing streaming session. See operation 354 of FIG. 5 and operation 408 of FIG. 6. While the session message that informs of the changes to the configuration of the ongoing streaming session may be provided in a variety of manners, the processor of one example embodiment may cause an RTSP message to be provided to the client device. The RSTP message may be configured so as to identify the change in the configuration as well as the time at which the change in the configuration will become effective. The session message may identify the change in configuration in various manners such as by providing a new session description or by providing an update to the session description of an ongoing session, along with an indication of the time at which to apply the new session description and/or to apply the update to the session description of the ongoing streaming session. In this regard, one example of a notification message that may be sent over the session control connection to the client device, termed a PLAY_NOTIFY message, may be as follows:
S->C: PLAY_NOTIFY rtsp://www.nokia.com/content1 RTSP/1.0
Date: Tue, 14 Jun. 2010 10:04:18 GMT
CSeq: 532
Notify-Reason: session-update
Session: uM3ci0J+Kd
Switch-Stream: old=http://www.nokia.com/content1/trackID=1; new=http://www.nokia.com/content2/trackID=2
Range: npt=2:01:24.568-
Content-Type: application/sdp
Content-Length: 421
v=0
o=33405 135 0 IN IP4 10.42.43.1
s=Live
c=IN IP4 0.0.0.0
t=0 0
m=video 8234 RTP/AVP 96
a=rtpmap:96 H264/90000
a=framerate:25
a=fmtp:96 packetization-mode=1;profile-level-id=42c00b;
m=audio 8236 RTP/AVP 97
a=rtpmap:97 mpeg4-generic/22050
a=fmtp:97 streamtype=5; profile-level-id=15; mode=AAC-hbr;
C→S: RTSP/2.0 200 OK
CSeq: 532
User-Agent: Nokia Media Player/5.0
Session: uM3ci0J+Kd

As will be noted, the body of the PLAY_NOTIFY message may include a new SDP file associated with the change to the configuration of the ongoing streaming session. In addition, in instances in which an existing media stream will be replaced with a new media stream, the session message may include the address, such as the URL, at which the existing media stream was located as well as the address, such as the URL, of the new media stream. In the foregoing example, the URLs of the existing and the new media streams are identified as the “old” and “new” media streams, respectively, following the switch-stream header. In other instances in which a new media stream is to be provided without replacing an existing media stream or in which an existing media stream is to be discontinued without being replaced by a new media stream, the session message may only identify a “new” media stream or an “old” media stream, respectively, but not both a “new” media stream and an “old” media stream. In addition, the time at which the change will become effective, such as the time at which the new media stream will effectively replace the existing media stream is also identified, such as following the range header. As noted above, the client device 100 may also respond to the server 106 indicating the receipt of the session message, such as by means of a “200 OK” message.

In other instances, an ongoing streaming session that involves the content that is to be changed is not supported by a persistent session control connection, such as in instances in which the RTSP session has been terminated and the TCP session control connection has been torn down. Thus, the server 106 may include means, such as the processor 205, the communication interface 215 and/or the like, for causing a notification to be transmitted from the server to the client device 100 that is related to a change of the configuration of the ongoing streaming session so as to cause the client device to establish a session control connection. See operation 352 of FIG. 5 and operation 410 of FIG. 6 as well as the following discussion of the notification in conjunction with the operation of the client device. For example, the server, such as the processor, may cause the notification to be transmitted in-band as part of a media session, such as within data packets of the ongoing streaming session. Alternatively, the server, such as the processor, may cause the notification to be transmitted out-of-band, such as an Open Mobile Alliance (OMA) PUSH message or a Short Message Service (SMS) message. In order to improve reliability by increasing the likelihood that the client device will receive the message, the server, such as the processor, may cause the notification to be transmitted to the client device via a plurality of media streams, e.g., all available media streams, and/or in a repeated fashion so that multiple copies of the notification are transmitted. Following the establishment by the client device of a session control channel with the server in response to the notification as described below, the server, such as a processor, may cause a session message to be provided to the client device via the recently established session control connection to inform the client device of a session update that changes the configuration of the ongoing streaming session in the manner described above in conjunction with operation 354 of FIG. 5 and operation 408 of FIG. 6.

Based upon the session message informing the client device 100 of the change to the configuration of the ongoing streaming session and the receipt of a confirmatory message from the client device, the server 106 may anticipate that the ongoing streaming session will change in the manner defined by the notification at the time at which the change is to become effective. As such, the server may be configured to effect the change, such as by changing the media streams delivered or streamed to the client device and/or by changing the media configuration of one or more existing media streams, in the manner previously defined by the notification at the time at which the change is to become effective.

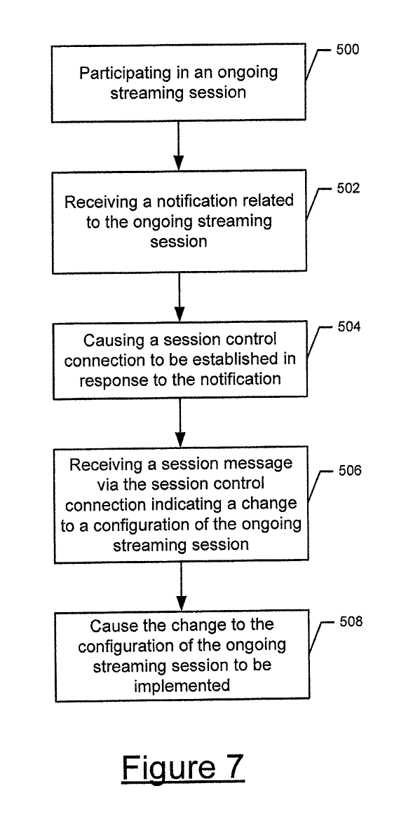

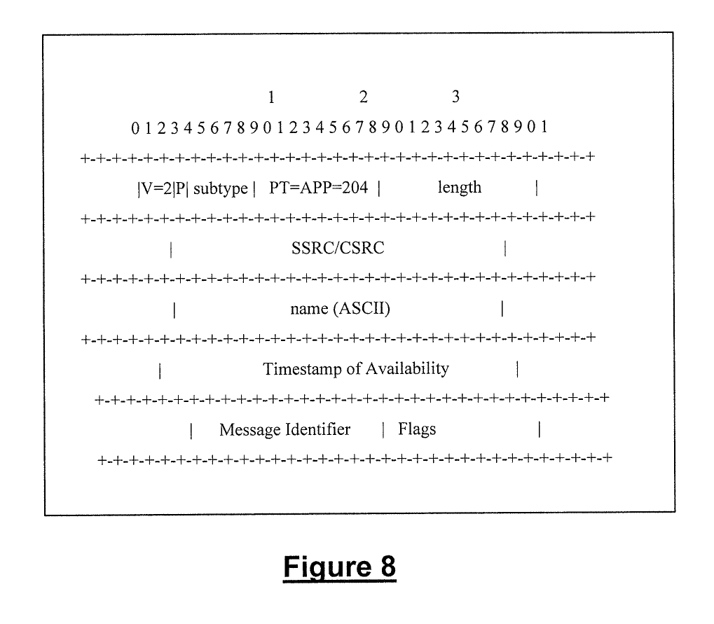

From the perspective of a client device 100, such as a mobile terminal 300 of FIG. 4, the client device may also include means, such as a processor 320, for participating in an ongoing streaming session. See operation 500 of FIG. 7. As noted above, the ongoing streaming session may have been set up by the exchange of RTSP messages via an RTSP session supported by a session control connection, such as a TCP connection, but the TRSP session may have been terminated and the session control connection torn down once one or more media sessions, such as RTP sessions, have been established. Thus, the session control connection may be a non-persistent connectionA variety of different types of content, such as audio, video or other media or other content, may be streamed to the client device via respective media streams. In accordance with an example embodiment, the client device may include means, such as the processor, the receiver 14 and/or the like, for receiving a notification related to an ongoing streaming session in instances in which the session control channel has been torn down and is therefore non-persistent. See operation 502 of FIG. 7. The notification may include a request for establishing a session control connection and/or an indication of an outstanding session message. The notification may be provided in a variety of manners, but in one embodiment, may be provided as an RTP Control Protocol (RTCP) message, such as an RTCP Application (APP) packet. In this embodiment, an Outstanding Session Notification Message (OSNM) APP report block may be defined, for example, as shown in FIG. 8.

As will be recognized, the first three rows, or twelve bytes, of the OSNM APP report block may be the same as a generic APP packet. However, the timestamp of availability that is included within the OSNM APP report block may indicate the time at which the outstanding session message will become available. Additionally, the message identifier field may include an identifier that uniquely identifies the notification across multiple media sessions in order to avoid, for example, a notification that has been received and is previously known to a client device 100 from being mistaken as a new notification. Additionally, flags may be included within the OSNM APP report block to identify the relative urgency or priority of the notification. While the OSNM APP report block described above is one example of a notification that may be provided by the server 106 and received by the client device for indicating that a session message regarding the ongoing streaming session is outstanding, the server may provide and the client device may receive a wide variety of other notifications configured in different manners in other embodiments.

Regardless of the particular format of the notification that indicates, for example, that a session message regarding the ongoing streaming session is outstanding, the client device 100 may include means, such as processor 320, for causing a session control connection to be established in response to receipt of the notification. See operation 504 of FIG. 7. For example, the client device may be configured to establish a session control connection, such as anTCP connection that supports an RTSP session, in response to receipt of the notification. The client device may also include means, such as the processor, the receiver 316 and/or the like, for receiving a session message indicating a change to the configuration of the ongoing streaming session via the session control connection that has now been established. See operation 506 of FIG. 7. While the session message that indicates the change to the configuration of an ongoing streaming session may be provided in a variety of manners, one example of such a session message was described above in conjunction with the server in the form of a PLAY_NOTIFY message that is provided via an RTSP signaling method. As also described above, the session message that informs of the change to the configuration of the ongoing streaming session may include a new session description or may include an update to the session description of an ongoing session, along with an indication of the time at which to apply the new session description and/or to apply the update to the session description of the ongoing streaming session.

As such, the client device 100 may also include means, such as processor 320, the receiver 316 and/or the like, for causing the change to the configuration of the ongoing streaming session to be implemented. See operation 508 of FIG. 7. In instances in which the change to the configuration of the ongoing streaming session is to become active at a particular time, the client device may be configured to cause the change to the configuration of the ongoing streaming session to be implemented at the respective time so as to remain synchronized with the server 106. The change to the configuration of the ongoing streaming session that is implemented may take various forms. For example, an existing media stream may be discontinued such that the client device, such as the processor, may tear down the session, such as an RTP session, that previously supported the media stream. Additionally, or alternatively, a new media stream may be identified to be streamed to the client device such that the client device, such as the processor, may establish a new session, such as an RTP session established using an RTSP SETUP message. Still further, the change to the configuration of the ongoing streaming session may involve the replacement of one or more existing media streams with one or more new media streams. In this instance, the client device, such as the processor, may map the one or more new media streams to the one or more existing media streams and may thereafter replace an existing media stream with the respective new media stream. In one embodiment, the client device, such as the processor may commence any preparatory work required to implement the change in configuration prior to, e.g., seconds prior to, the time at which the change in the configuration becomes effective to insure that the change in configuration may take effect at the designed time.

By providing a mechanism for notifying a client device 100 of an impending change to the configuration of an ongoing streaming session, the change to the configuration of the ongoing streaming session may be implemented in an efficient and orderly manner, even in instances in which the ongoing streaming session is a unicast streaming session supported by a non-persistent connection. Thus, changes to the media streams and/or changes to the media configuration that comprise the ongoing streaming session may be implemented in a manner that is seamless to the user and may therefore provide for an improved user experience.

As described above, FIGS. 5-7 illustrate flowcharts of example systems, methods, and/or computer program products according to example embodiments of the invention. It will be understood that each operation of the flowcharts, and/or combinations of operations in the flowcharts, can be implemented by various means. Means for implementing the operations of the flowcharts, combinations of the operations in the flowchart, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions for performing the operations and functions of FIGS. 5-7 and otherwise described herein may be stored on a memory device, such as memory device 210 of the server 106 or volatile memory 30 and/or non-volatile memory 342 of a mobile terminal 300, and executed by a processor, such as the processor 205 of the serer or processor 320 of the mobile terminal. As will be appreciated, any such program code instructions may be loaded onto a computer or other programmable apparatus (e.g., processor 205 of the server or processor 320 of the mobile terminal) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation

What is claimed is:

1. A method comprising:
determining that a configuration of an ongoing streaming session is to change;
causing a notification related to a change of the configuration of the ongoing streaming session to be provided from a server to a client device, said notification being provided to cause the client device to establish a session control connection with the server; and
causing a session message to be provided from the server to the client device, via the session control connection, to inform the client device of at least one session update that changes the configuration of the ongoing streaming session.

2. A method according to claim 1 wherein the session message provided from the server to the client device comprises at least one of:
a session description protocol file;
an update to the session description protocol file of the ongoing streaming session;
a time at which the session update becomes effective;
an indication of switching from an old media stream to a new media stream;
an indication of an old media stream to be discontinued; and
an indication a new media stream to be provided.

3. A method according to claim 1 wherein causing the notification to be provided comprises at least one of:
including an indication within the notification of a time at which the session message will be available;
causing the notification to be transmitted in-band from the server to the client device as a portion of one or more data packets of the ongoing streaming session; and
causing the notification to be transmitted out-of-band from the server to the client device.

4. A method according to claim 1 wherein the notification comprises a real-time transport control protocol (RTCP) message.

5. A method according to claim 1 wherein determining that the configuration of an ongoing streaming session is to change comprises receiving an indication that the session update is scheduled for respective content and identifying one or more ongoing streaming sessions involving the respective content.

6. A method according to claim 1 wherein the session message comprises a real-time streaming protocol (RTSP) message.

7. An apparatus comprising:
at least one processor; and
at least one memory including computer program code, the at least one memory and the computer program code configured to, with the at least one processor, cause the apparatus to perform at least the following:
determine that a configuration of an ongoing streaming session is to change;
cause a notification related to a change of the configuration of the ongoing streaming session to be provided from a server to a client device, said notification being provided to cause the client device to establish a session control connection with the server; and
cause a session message to be provided from the server to the client device via the session control connection to inform the client device of at least one session update that changes the configuration of the ongoing streaming session.

8. An apparatus according to claim 7 wherein the session message provided from the server to the client device comprises at least one of:
a session description protocol (SDP) file;
an update to the session description protocol file of the ongoing streaming session;
a time at which the session update becomes effective;
an indication of switching from an old media stream to a new media stream;
an indication of an old media stream to be discontinued; and
an indication a new media stream to be provided.

9. An apparatus according to claim 7 wherein the at least one memory and the computer program code are further configured to, with the at least one processor, cause the apparatus to perform at least one of:
include an indication within the notification of a time at which the session message will be available;
cause the notification to be transmitted out-of-band from the server to the client device; and
cause the notification to be transmitted in-band from the server to the client device as a portion of one or more data packets of the ongoing streaming session.

10. An apparatus according to claim 7 wherein the notification comprises a real-time transport control protocol (RTCP) message.

11. An apparatus according to claim 7, wherein the at least one memory and the computer program code are further configured to, with the at least one processor, cause the apparatus to determine that the configuration of an ongoing streaming session is to change by receiving an indication that a session update is scheduled for respective content and identifying one or more ongoing streaming sessions involving the respective content.

12. An apparatus according to claim 7 wherein the session message comprises a real-time streaming protocol (RTSP) message.

13. A computer program product comprising at least one computer-readable storage medium having computer-readable program code portions stored therein, the computer-readable program code portions, when executed by a processor cause an apparatus to:
determine that a configuration of an ongoing streaming session is to change;
cause a notification related to a change of the configuration of the ongoing streaming session to be provided from a server to a client device, said notification being provided to cause the client device to establish a session control connection with the server; and
cause a session message to be provided from the server to the client device via the session control connection to inform the client device of at least one session update that changes the configuration of the ongoing streaming session.

14. A method comprising:
receiving a notification at a client device from a server with the notification being related to a change of a configuration of an ongoing streaming session;
causing a session control connection with the server to be established by the client device in response to receipt of the notification from the server; and
receiving a session message at the client device from the server via the session control connection, wherein the session message is configured to inform the client device of at least one session update that changes the configuration of the ongoing streaming session.

15. A method according to claim 14 wherein the session message received at the client device from the server comprises at least one of:
a session description protocol file;
an update to the session description protocol file of the ongoing streaming session;
a time at which the session update becomes effective;
an indication of switching from an old media stream to a new media stream;
an indication of an old media stream to be discontinued; and
an indication a new media stream to be provided.

16. A method according to claim 14 further comprising causing a change to the configuration of the ongoing streaming session to be implemented by the client device in response to receipt of the session message.

17. A method according to claim 16 wherein causing the change to the configuration of the ongoing streaming session to be implemented comprises at least one of:
mapping one or more updated media streams to one or more existing media streams, and
replacing an existing media stream with an updated media stream.

18. A method according to claim 14 wherein receiving the notification at the client device from the server comprises receiving a time at which the session message will be available.

19. A method according to claim 14 wherein the notification comprises a real-time transport control protocol (RTCP) message.

20. A method according to claim 14 wherein the session message comprises a real-time streaming protocol (RTSP) message.

21. An apparatus comprising:
at least one processor; and
at least one memory including computer program code, the at least one memory and the computer program code configured to, with the at least one processor, cause the apparatus to perform at least the following:
receive a notification at a client device from a server with the notification being related to a change of a configuration of an ongoing streaming session;
cause a session control connection with the server to be established by the client device in response to receipt of the notification from the server; and
receive a session message at the client device from the server via the session control connection, wherein the session message is configured to inform the client device of at least one session update that changes the configuration of the ongoing streaming session.

22. An apparatus according to claim 21 wherein the session message received at the client device from the server comprises at least one of:
a session description protocol file;
an update to the session description protocol file of the ongoing streaming session;
a time at which the session update becomes effective;
an indication of switching from an old media stream to a new media stream;
an indication of an old media stream to be discontinued; and
an indication a new media stream to be provided.

23. An apparatus according to claim 21 wherein the at least one memory and the computer program code are further configured to, with the at least one processor, cause the apparatus to cause a change to the configuration of the ongoing streaming session to be implemented by the client device in response to receipt of the session message.

24. An apparatus according to claim 23 wherein the at least one memory and the computer program code are further configured to, with the at least one processor, cause the apparatus to cause the change to the configuration of the ongoing streaming session to be implemented comprises:
mapping one or more updated media streams to one or more existing media streams, and
replacing an existing media stream with an updated media stream.

25. An apparatus according to claim 21 wherein the notification received at the client device from the server includes a time at which the session message will be available.

26. An apparatus according to claim 21 wherein the notification comprises a real-time transport control protocol (RTCP) message.

27. An apparatus according to claim 21 wherein the session message comprises a real-time streaming protocol (RTSP) message.

28. A computer program product comprising at least one computer-readable storage medium having computer-readable program code portions stored therein, the computer-readable program code portions, when executed by a processor, cause an apparatus to:
receive a notification at a client device from a server with the notification being related to a change of a configuration of an ongoing streaming session;
cause a session control connection with the server to be established by the client device in response to receipt of the notification from the server; and
receive a session message at the client device from the server via the session control connection, wherein the session message is configured to inform the client device of at least one session update that changes the configuration of the ongoing streaming session.
